(19) United States
(12) Patent Application Publication
(10) Pub. No.: US 2021/0218488 A1
(43) Pub. Date: Jul. 15, 2021

(54) MULTISENSOR DATA FUSION SYSTEMS AND METHODS

(71) Applicant: OLYMPUS CORPORATION, Tokyo (JP)

(72) Inventors: Tao Zhang, San Diego, CA (US); Shinhaeng Lee, San Diego, CA (US); Thomas Truong, San Diego, CA (US); Hong Jo Ahn, San Diego, CA (US)

(21) Appl. No.: 17/054,106

(22) PCT Filed: May 10, 2018
(86) PCT No.: PCT/IB2018/001639

§ 371 Date: Nov. 9, 2020

(51) Int. Cl. H04J 3/06; G06K 9/62; H04W 56/00; H04W 84/18

(52) U.S. Cl. CPC H04J 3/065; H04J 3/0682; H04W 84/18; G06K 9/623; H04W 56/0015; G06K 9/6289

(57) ABSTRACT

Systems and methods for multi-sensor data fusion include: a counter circuit, measuring a clock rate of a local clock and outputting a difference value associated with the local clock and a counter value; a data collection and counterstamp circuit comprising a plurality of inputs to receive data from a plurality of sensors and a plurality of outputs, wherein the sensors are not synchronized with the multi-sensor data fusion system, and wherein the data collection and counterstamp circuit determines a sample delay for received sensor data and determines a timestamp corresponding to the measurement time for received sensor data using the determined sample delay; and a data fusion circuit comprising a plurality of inputs to receive sensor data from the data collection and counter stamp circuit, the data fusion circuit outputting information with even output timing, synchronized with an application processor.

### REFERENCE TO RELATED APPLICATION

The present application is the U.S. national phase of and claims priority to International Patent Application No. PCT/IB2018/001639, filed May 10, 2018 and titled “MULTISENSOR DATA FUSION SYSTEMS AND METHODS,” which is incorporated herein by reference in its entirety.

### TECHNICAL FIELD

The disclosed technology relates generally to sensor data collection, and more particularly some embodiments relate to systems and methods for managing data from a plurality of sensors.

### DESCRIPTION OF THE RELATED ART

Multi-sensor data fusion has become increasingly popular as sensor technology has increased and sensors have become more affordable. Multi-sensor data fusion relies on data obtained from a plurality of sensors often deployed at different locations to allow the different types of data to be gathered, depending on the application. A fusion core can be included to combine and correlate the data and provide a sensor fusion output, which may often be in the form of a decision or an estimation. Fusing multi-sensor data generally allows a greater amount of information to be considered in a decision-making process, which can lead to increased certainty and precision and sensor system decisions, estimates or other output. Multi-sensor data fusion now enjoys applicability in a wide array of applications, including aerospace and defense, environmental monitoring, healthcare monitoring and medical diagnosis, mechanical and electro-mechanical systems monitoring, and so on.

Despite the increasing popularity of multi-sensor data systems, there are still challenges faced by these systems. Typically, the various sensors within the multi-sensor data system are not synchronized with one another, they often utilize different interfaces and different timing intervals, and they may be subject to different levels of latency within the system. This can create challenges for the fusion core or other centralized processing system that is attempting to gather data from the various sensors and provide useful output based on the sensed data that is collected.

Prior solutions to this challenge have been proposed and implemented with varying degrees of success. One solution assumes that the sensors have a regular measurement time, or a fixed interval, and effectively treats unsynchronized sensors as synchronized. These systems may also assume that the amount of delay from measurement time to observation time is the same across all sensors. However, not accounting for different measuring times, varying intervals or varying delays can lead to inaccuracies in the final prediction or conclusion rendered by the processing system. For example, consider the application of a volumetric positioning system such as, for example, a GNSS system. If multiple positioning data points are received from multiple sensors, but the actual time of each measurement is not known, positioning estimates made by the fusion core will generally suffer from resulting inaccuracies. Another solution synchronizes the sensors and the processing system clock to a centralized clock. However, the cost of the hardware/software necessary to synchronize these clocks to a unique clock source can be high and in some cases cost prohibitive. Yet another solution attempts to use interpolation or extrapolation, or a combination thereof, to align the clocks using a software algorithm. This can result in additional computational complexity and may still fail to achieve sufficient accuracy depending on the application. Kalman filtering has also been commonly used in multi-sensor data fusion systems.

### BRIEF SUMMARY OF EMBODIMENTS

Embodiments of the technology disclosed herein are directed toward devices and methods for multi-sensor data fusion. In various embodiments, a multi-sensor data fusion system, includes: a counter circuit, including a counter and a plurality of registers, the counter circuit measuring a clock rate of a local clock and outputting a difference value associated with the local clock and a counter value; a data collection and counterstamp circuit including a plurality of inputs to receive data from a plurality of sensors and a plurality of outputs, wherein the sensors are not synchronized with the multi-sensor data fusion system, and wherein the data collection and counterstamp circuit determines a sample delay for received sensor data and determines a timestamp corresponding to the measurement time for received sensor data using the determined sample delay; and a data fusion circuit including a plurality of inputs to receive sensor data from the data collection and counter stamp circuit, the data fusion circuit outputting information with even output timing, synchronized with an application processor.

The data collection and counterstamp circuit time may stamp received sensor data with the determined timestamp, and send sensor data with its associated timestamp reflecting its sensing time to the data fusion circuit. The data collection and counterstamp circuit may determine the timestamp using the counter value from the local clock, the measured clock rate of the local clock and the determined sample delay.

In further embodiments, the sensor data received from sensors in a sensor system may include a sensor time stamp and the sensor system provides the reference timing signal, further wherein data collection and counter stamp circuit may generate the timestamp using the counter value when a reference point from the reference timing signal is received.

The multi-sensor data fusion system may further include a plurality of buffers coupled between outputs of the data collection and counter stamp circuit and inputs of the data fusion circuit.

The counter circuit may include an input to receive a local clock signal and an input to receive a reference timing signal, further wherein the counter circuit uses the reference timing signal to calibrate the local clock signal. In various embodiments, calibrating the local clock signal may include determining a difference between a value of the counter at a first reference time of the reference timing signal and a second reference time of the reference timing signal.

The data fusion circuit may include a Kalman filter to process sensor data received from the data collection and counter stamp circuit. The data fusion circuit may include a prediction matrix and an update matrix, wherein a prediction is performed using the prediction matrix at the measurement time of any sensor, and the output time, and an update is performed at the measurement time of a sensor using the update matrix associated with the sensor. The measurement times of sensors and the time of fusion output may be on an irregular timing basis.

In various embodiments, the predicted values are determined as:

\hat{X}ₜ₍ₖ₎=A_{δt(k)}\hat{X}ₜ₍ₖ₋₁₎+B_{δt(k)}Uₜ₍ₖ₋₁₎Pₜ₍ₖ₎=A_{δt(k)}Pₜ₍ₖ₋₁₎A_{δt(k)}^{T}+Q_{δt(k)},

where \hat{X}ₜ₍ₖ₎ is estimated state vector at time k, The required output can be derived from state vector; A_{δt(k)} is relating transformation matrix from X_{K-1} to X_{K}; Pₜ₍ₖ₎ is the estimation error vector of \hat{X}ₜ₍ₖ₎; Uₜ₍ₖ₋₁₎ is the vector (n×1) containing any control inputs, B_{δt(k)} is the control input matrix (n×n) which applies the effect of control input; Q_{δt(k)} is covariance structure of process error associated to time period from X_{K-1} to X_{K}.

The updated state vector and estimation error vector based on measurement results of first sensor may be determined as:

\hat{X}ₜ₍ₖ₎⇐\hat{X}ₜ₍ₖ₎+K_{1,t(k)}(Z_{1,t(k)}−H₁\hat{X}ₜ₍ₖ₎)Pₜ₍ₖ₎⇐Pₜ₍ₖ₎−K_{1,t(k)}H₁Pₜ₍ₖ₎,

where Z_{1,t(k)} is the measurement/observation vector of first sensor at timing t(k), H₁ is matrix relating state vector to observation/measurement of first sensor, K_{1,t(k)} is Kalman filter gain for first sensor, and determined as:

K_{1,t(k)}=Pₜ₍ₖ₎H₁^{T}(H₁Pₜ₍ₖ₎H₁^{T}+R₁)⁻¹,

where R₁ is the covariance structure of measurements noise.

The updated value state vector and estimation error vector based on measurement results of second sensor may be determined as:

\hat{X}ₜ₍ₖ₎⇐\hat{X}ₜ₍ₖ₎+K_{2,t(k)}(Z_{2,t(k)}−H₂\hat{X}ₜ₍ₖ₎)Pₜ₍ₖ₎⇐Pₜ₍ₖ₎−K_{2,t(k)}H₂Pₜ₍ₖ₎,

where Z_{2,t(k)} is the measurement/observation vector of second sensor at timing t(k), H₂ is matrix relating state vector to observation/measurement of second sensor, K_{2,t(k)} is Kalman filter gain for second sensor, and determined as:

K_{2,t(k)}=Pₜ₍ₖ₎H₂^{T}(H₂Pₜ₍ₖ₎H₁^{T}+R₂)⁻¹,

where R₂ is the covariance structure of measurements noise.

The data fusion circuit may include state-space equations having a variable updating interval, and de-coupled updating and prediction times. The data fusion circuit may perform prediction and updating in the order of sensing time of each sensor data sample. The data fusion circuit may perform prediction and updating corresponding to a sensing time based on the counter value. The prediction may correspond to the requested output time.

In further embodiments, a method for performing multi-sensor data fusion system may include a counter circuit measuring a clock rate of a local clock and outputting a difference value associated with the local clock and a counter value; a data collection and counterstamp circuit determining a sample delay for received sensor data and determines a timestamp corresponding to the measurement time for received sensor data using the determined sample delay; and a data fusion circuit outputting information with even output timing, synchronized with an application processor.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example of a multi-sensor data system in accordance with one embodiment of the systems and methods described herein.

FIG. 2 is a diagram illustrating an example of data fusion circuitry in accordance with one embodiment of the systems and methods described herein.

FIG. 3 illustrates an example process for operating data fusion circuitry 246 in accordance with one embodiment of the systems and methods described herein.

FIG. 4 illustrates an example counter circuit that may be implemented as counter system in accordance with one embodiment of the systems and methods described herein.

FIG. 5 illustrates an example process for determining a clock rate using the example counter circuit of FIG. 4 in accordance with one embodiment of the systems and methods described herein.

FIG. 6 illustrates an example of measurement times for 2 sensors and the time at which sensor data is observed by data fusion circuitry in accordance with one embodiment of the systems and methods described herein.

FIG. 7 illustrates an example timing diagram of GNSS (Global Navigation Satellite System) timing signals and GNSS messages.

FIG. 8 illustrates an example process for computing an appropriate counterstamp for data received in accordance with one embodiment of the systems and methods described herein.

FIG. 9 illustrates an example block diagram for an IMU in accordance with one embodiment of the systems and methods described herein.

FIG. 10 illustrates an example process for computing the counterstamp using information from the example IMU system.

FIG. 11 illustrates an example of different computations that can be performed at different times in the process in accordance with one embodiment of the systems and methods described herein.

FIG. 12 is a diagram illustrating an example computing system that can be used as one way to implement circuitry described herein.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

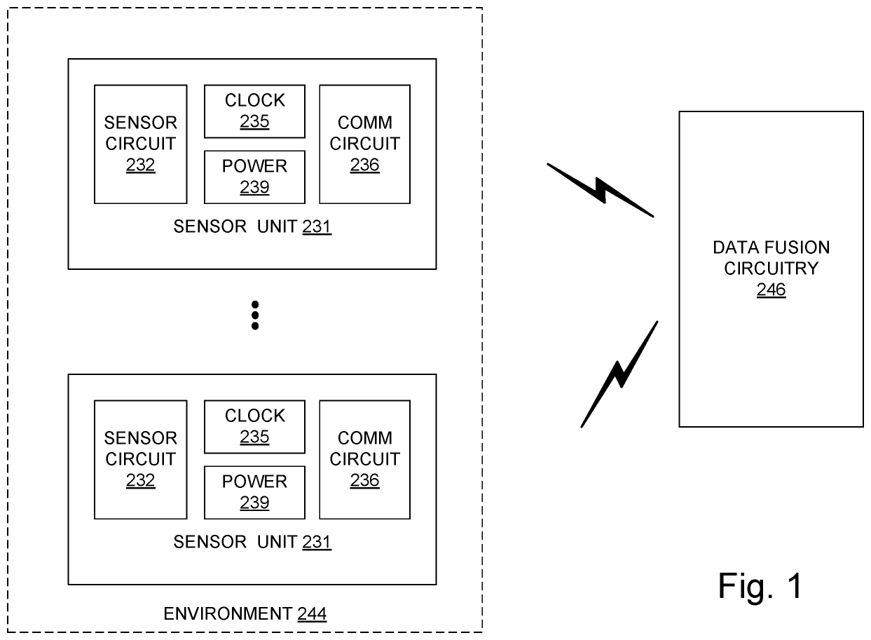

FIG. 1 illustrates an example of a multi-sensor data system in accordance with one embodiment of the systems and methods described herein. This example includes a plurality of sensor units 231 operating within an environment 244. Sensor units 231 collect sensor data from the environment 244 and send this information back to data fusion circuitry 246. Environment 244 can include any of a number of different environments to be monitored depending on the application. For example, environment 244 can include one or more of complex machinery, healthcare facilities, tools and equipment, aerospace and defense systems, motor vehicles and other conveyances, power generation facilities, volumetric positioning systems, and so on.

In the illustrated example, sensor units 231 include a sensor circuit 232, a sensor clock 235, a communication circuit 236, and a power supply 239. Sensor circuit 232 can be chosen and implemented to sense any of a wide variety of conditions or parameters. For example, sensor circuit 232 might sense conditions such as environmental conditions (e.g., pressure, temperature, humidity, rainfall, etc.), physical conditions (e.g., strain, stress, weight, torque, etc.), device conditions (e.g. RPM, torque, position, vibration, component temperature, stroke, displacement, rotation, etc.); and positioning conditions (e.g., position, attitude, distance, straightness, squareness, GNSS data etc.).

In some applications, sensor unit 231 may include an internal clock 235 that can be used to time operation of sensor unit 231 such as, for example, to provide timing for sensor measurements or for transmitting data to data fusion circuitry 246. In some embodiments, clocks 235 can be synchronized among multiple sensor units 231 and among data fusion circuitry 246, while in other embodiments, clocks 235 can run asynchronously.

Sensor units 231 may also include a power supply 239. Power supply 239 may include, for example, one or more batteries, photovoltaic cells, capacitive storage units, AC-to DC power converters, and so on. In some applications, sensor units 231 may be implemented as passive sensors that receive power from an interrogation signal. An example of a passive sensor can include a passive RFID tag.

Communication circuit 236 can be implemented as a hard wired or wireless communications interface to transmit sensor data from sensor unit 231 to data fusion circuitry 246 or other destinations. In some embodiments, communication circuit 236 can also be implemented to receive data from data fusion circuitry 246 or other sources. Although the communication link between sensor units 231 and data fusion circuitry 246 is illustrated as a direct communication link, other embodiments may include an indirect vacation link such as, for example, communication fire a network of devices.

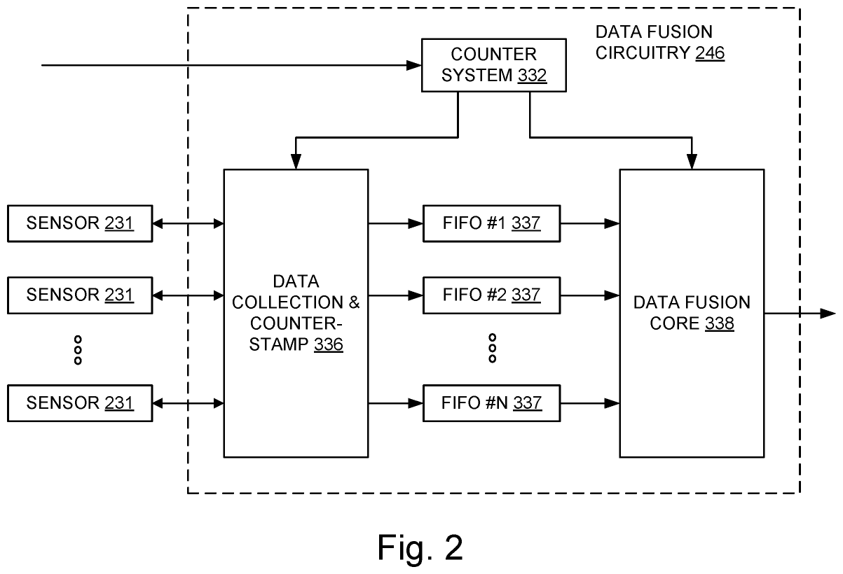

FIG. 2 is a diagram illustrating an example of data fusion circuitry 246 in accordance with one embodiment of the systems and methods described herein. In this example, data fusion circuitry 246 includes a counter system 332, data collection and counterstamp circuitry 336, a plurality of FIFOs 337 and a data fusion core 338. In this example, data received from a plurality of sensors (e.g., sensors 231 of FIG. 1) are received at data collection and counterstamp circuitry 336 where they are counterstamped. The counterstamped sensor data is then queued at the FIFOs 337 and forwarded to data fusion core 338 for data fusion. In various applications, the sensors 231 may be running asynchronously. Accordingly, when the data is received, data fusion circuitry 246 attempts to determine the original sensing time (e.g., when the data was captured) for data received from each sensor, stamp it with a counterstamp and provided to the queue to send to the data fusion core 338.

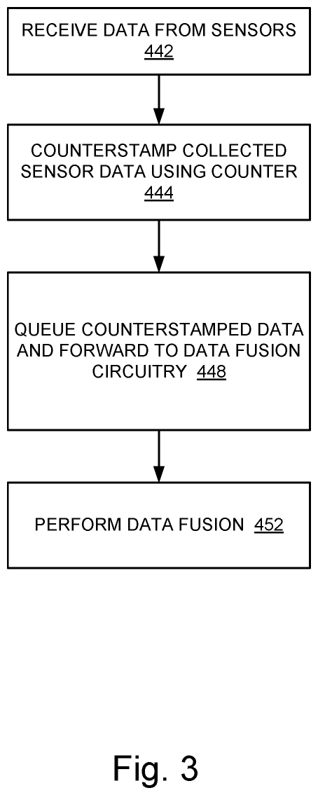

FIG. 3 illustrates an example process for operating data fusion circuitry 246 in accordance with one embodiment of the systems and methods described herein. With reference now to FIGS. 2 and 3, at operation 442 data fusion circuitry 246 receives data from operating sensors 231. At operation 444, data received by data collection and counterstamp circuitry 336 is stamped with a counter value determined by counter system 332, as described in more detail below. The counterstamp data is skewed at FIFOs 337 and forwarded to data fusion core 338 at operation 448. At operation 452 data fusion core 338 performs data fusion on the sensor data.

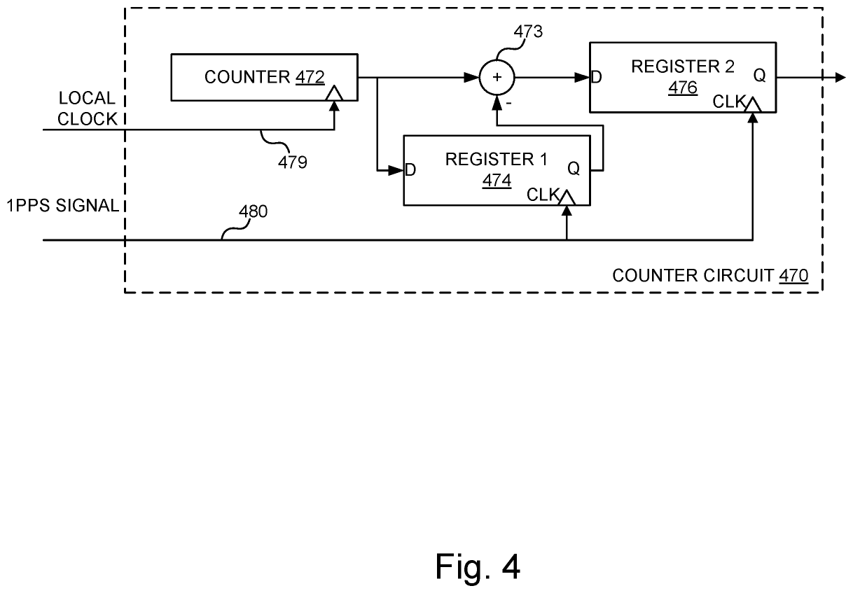

FIG. 4 illustrates an example counter circuit that may be implemented as counter system 332 in accordance with one embodiment of the systems and methods described herein. This example counter circuit 470 includes a counter 472, a summer 473, and two registers 474, 476. In this example, counter 472 is a free running counter that is driven by a reference clock signal 479. Reference clock signal 479 can be a local clock signal generated, for example, at data fusion circuitry 246. In various embodiments, this clock need not be synchronized with the sensors or the sensor clocks. Depending on the application, local clock may have a relatively high frequency such as, for example, in the range of 10 MHz to 200 MHz, although the local clock can be provided to operate at other frequencies.

Registers 474, 476 are clocked by a reference signal 480. In this example, reference signal 480 is a one pulse per second (PPS) signal, although other reference signals can be used. Reference signal 480 is used to clock values into registers 474, 476 so that the clock rate can be determined. Accordingly, registers 474, 476 can have the same bit width as or a greater bit width than counter 472. Counter circuit 470 can output the difference value stored in register 2 476 and the raw counter value from counter 472.

Reference signal 480 can be an internal or external calibration signal. For example, in one application, the system can use a GNSS 1PPS signal from a GNSS receiver. The GNSS receiver can be synchronized with GNSS satellites to provide a high accuracy with 1PPS signal. Because reference timing signal 480 is used to time the operations, a relatively high level of accuracy in the signal is desired. In some embodiments, the jitter of the reference timing signal 480 can be less than 10 ns (nanoseconds).

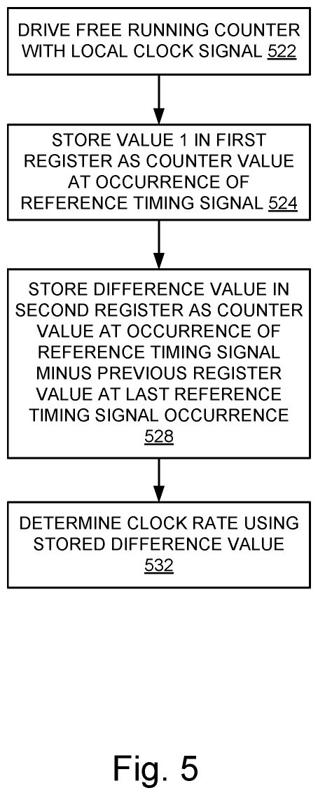

FIG. 5 illustrates an example process for determining a clock rate using the example counter circuit of FIG. 4 in accordance with one embodiment of the systems and methods described herein. With reference now to FIGS. 4 and 5, at operation 522 free running counter 472 is driven with the local clock signal 479. At operation 524, upon the occurrence of a pulse or triggering edge from the reference timing signal 480 at a time tₓ, the current counter value (of counter 472) at time tₓ is stored in register 1 474. At operation 526, also at time tₓ, the difference between the current counter value at time tₓ and the counter value at the immediately preceding pulse or triggering edge from reference timing signal 480 (stored in register 1 474 at time tₓ₋₁) is stored in register 2 476. In this configuration, register 2 476 stores the counted number of clock pulses (counted by counter 472) between pulses of the reference signal 480. At operation 532, the clock rate of local clock signal 479 is determined using the stored difference value in register 2 476. For example, where the reference signal 480 is a 1 PPS signal, the value stored in register 2 476 is the measured clock rate, R_clock. This measured clock rate can be used for data fusion.

As noted above, in some embodiments the local clock may be a relatively high rate (e.g., in the range of 10 MHz to 200 MHz). A reference signal with a jitter of 10 ns (or less) can provide accuracy of 10 ppb (parts-per-billion) for these clocks.

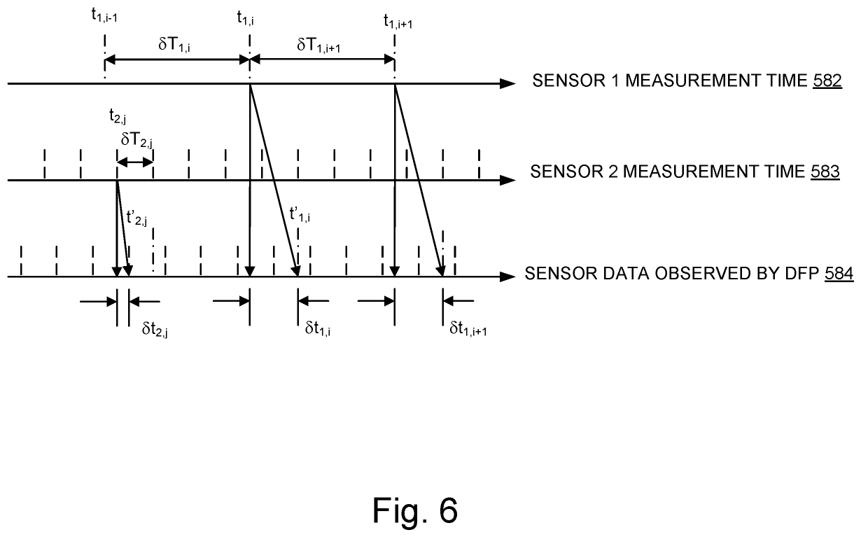

In various embodiments, each sensor (e.g. sensor 231) may have its own clock and algorithm to determine the time at which sensor data was captured. Likewise, in various embodiments, the capture time interval is not fixed, and the sensors are not synchronized. FIG. 6 illustrates an example of measurement times for 2 sensors and the time at which sensor data is observed by data fusion circuitry (e.g., data fusion circuitry 246). This simplified example assumes there are 2 sensors communicatively coupled to the data fusion circuitry. After data is captured by the sensors, it would experience various delays due to buffering, processing, communication latency, and so on, before the data is observed by the fusion data circuitry. Because of differences in sensors, sensor positions, sensor clocks, and so on, the interval and delay times is different among the various sensors. As shown in FIG. 6, for example, sensor 1 has different measurement times 582, t_{1,i}, and measurement time intervals δT_{1,l}, as compared to the sensor 2 measurement times 583, t_{2,j}, and interval δT_{2,j}. Also, in various applications, the interval and delay for a given sensor may also be different. For example, for sensor 1, the measurement time interval δT_{1,l} may be different from the next measurement time interval δT_{1,i-1} (and so on), and delay δt_{1,i} may be different from the delay for the next event δt_{1,i-1} (and so on).

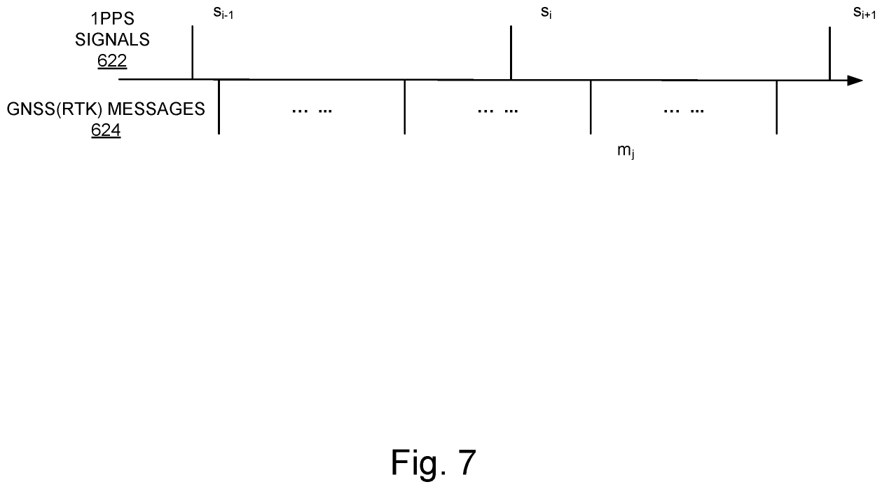

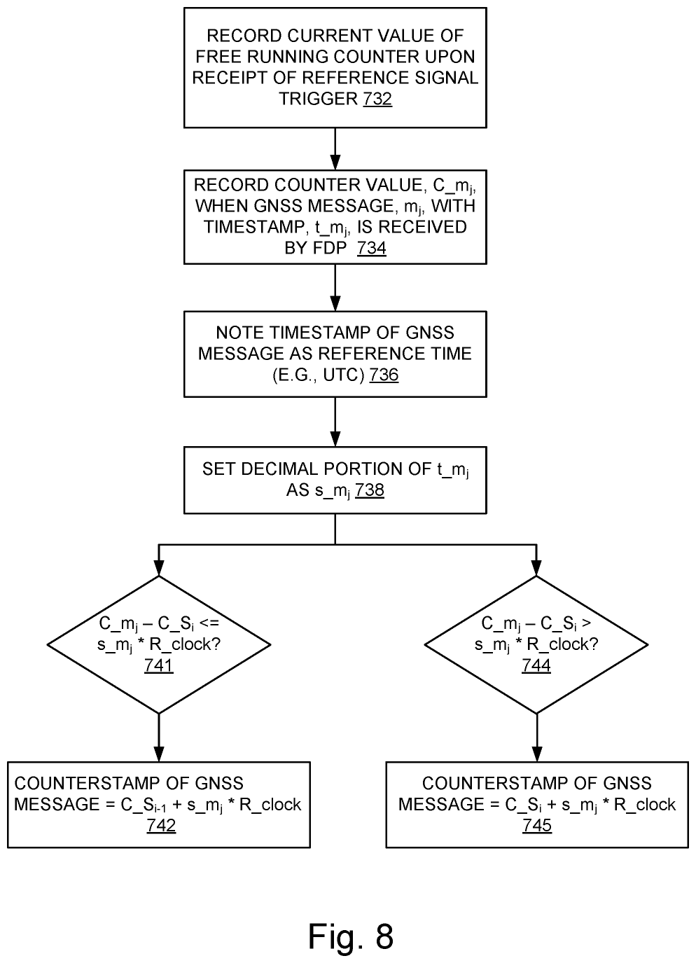

Accordingly, data collection and counterstamp circuit 336 can read the sensor data, determine the counter value associated with the original measurement time of that data, and write both the data and the measurement time into the corresponding FIFO register 337. For example, one embodiment is described in terms of the application of a positioning system using a Global Navigation Satellite Systems (GNSS) receiver. The GNSS receiver can be configured to run on its own clock, and external clock, or a clock derived from an interface between a GNSS module and a host. However, the GNSS receiver may produce data with timing that is independent of the clock used, but the GNSS receiver may have accurate UTC (Coordinated Universal Time) timing information. In many applications, a GNSS receiver may produce one or more messages per second, and some or all of these messages may include position information and a relatively high-precision UTC timestamp. The GNSS receiver may also provide a 1 PPS signal, which may be synchronized with a UTC timing boundary. This 1 PPS signal can be used as a reference signal (e.g. reference signal 480) for the fusion circuitry. FIG. 7 illustrates an example timing diagram of GNSS timing signals and GNSS messages. FIG. 8 illustrates an example process for computing an appropriate counterstamp for data received in accordance with one embodiment of the systems and methods described herein. The example of FIG. 8 is described in terms of the specific example of GNSS messages received as shown in FIG. 7. As illustrated in FIG. 7, the GNSS 1 PPS signal 622 provides a pulse, Sᵢ₋₁, Sᵢ, Sᵢ₊₁, . . . , every second. This example also shows GNSS messages 624, mᵢ.

Referring now to FIGS. 7 and 8, at operation 732 a current value of a free running counter is recorded upon receipt of a reference signal trigger. For example, in terms of the example counter circuit 470 (FIG. 4), the current value of counter 472 is stored in register 1 474 when a pulse of the 1 PPS signal 622 clocks the register. Accordingly, register 1 474 can be updated each time the 1 PPS signal 622 clocks the register. According to the example of FIG. 7, when 1pps signals Sᵢ₋₁, Sᵢ, . . . arrive at the data fusion circuitry, the counter values, C_Sᵢ₋₁, C_Sᵢ, . . . corresponding to their respective arrival times are recorded.

At operation 734, when the GNSS message, mⱼ, with timestamp t_mⱼ arrives at the data fusion circuitry, the corresponding counter value, C_mⱼ is also recorded. This corresponding counter value can be stored in a register of data collection and counterstamp circuitry 336. At operation 736, the timestamp of the message is used to determine the measurement time of the received message. For example, in the case of a GNSS message, the GNSS timestamp can be used to indicate the measurement UTC time of the received message.

At operation 738, the system (e.g., data collection and counterstamp circuitry 336) takes the decimal part of the timestamp for the message, t_mⱼ, and sets this as s_mⱼ (within 1 second). The system then determines at operations 741, 744 the relationship between C_mⱼ−C_Sᵢ on the one hand, and s_mⱼ* R_clock on the other hand. Particularly, at operation 741, the system determines whether the difference between the counter value at the time the message was received and the counter value at the time of the reference signal is less than or equal to the decimal part of the timestamp multiplied by the measured clock value, R_clock. This can be shown as

C_mj−C_Si<=s_mj*R_clock.

If this relationship is true, this indicates that the subject message data was measured between C_Sᵢ₋₁ and C_Sᵢ.

At operation 742, the system determines the counterstamp of the message accordingly. In this example, the system determines the counterstamp of the GNSS message as the counter value of the last reference signal plus the decimal portion of the message timestamp multiplied by the measured clock value:

C_Sᵢ₋₁+s_mⱼ*R_clock.

Returning to operation 744, If

C_mⱼ−C_Sᵢ>s_mⱼ*R_clock,

This indicates that the message data was measured between the time the counter value, C_Sᵢ, of the reference signal was recorded and the counter value, C_mⱼ, of the message was recorded. In this case, at operation 745, the counterstamp of the GNSS message is set as:

C_Sᵢ+s_mⱼ*R_clock

As the foregoing operation illustrates, using this process it is not necessary to synchronize a clock of the data fusion circuitry with the clock of the sensors (e.g. with the GNSS receiver clock in the example GNSS application)

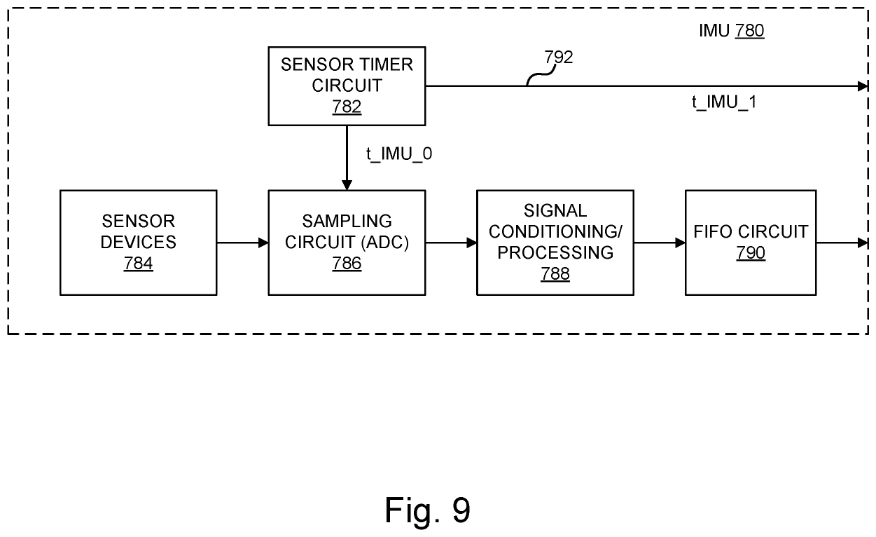

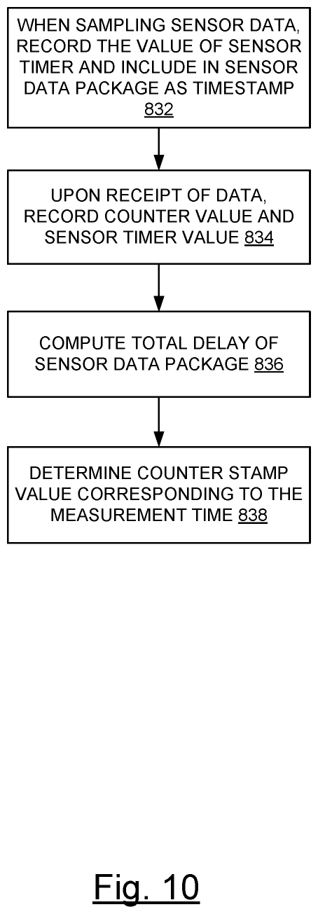

Another example embodiment for determining a counterstamp value utilizes information from the inertial measurement unit (IMU) of a positioning system. FIG. 9 illustrates an example block diagram for an IMU in accordance with one embodiment of the systems and methods described herein. FIG. 10 illustrates an example process for computing the counterstamp using information from the example IMU system. Referring now to FIGS. 9 and 10, in this example, IMU 780 includes a sensor timer 782, sensor devices 784, a sampling circuit 786 (e.g., an analog-to-digital converter (ADC)), signal processing and conditioning circuitry 788 and FIFO 790 (or other buffer circuit). In general, sensor devices 784 gather sensor data which is sampled by sampling circuit 786. Sensor timer 782 controls sampling by sampling circuit 786. Sampled data is conditioned/processed as appropriate by signal processing and conditioning circuitry 788 and buffered for transmission to data fusion circuitry. This sensor timer signal 792 can be read by the data fusion circuitry.

An example for determining a counterstamp for an IMU sensor such as that illustrated in FIG. 9, is now described. At operation 832, when sensor data is sampled, the value of sensor timer, t_IMU_0, is stored and it is included in the sensor data package as a timestamp for the sensor data. The sensor data package with the timestamp is sent to the data fusion circuitry (e.g. data fusion circuitry 246 of FIG. 2).

At operation 834, when the data fusion circuitry receives the data package from the sensor, the data fusion circuitry (e.g. data collection and counterstamp circuitry 336) records the current counter value, C_imu, and reads the current sensor timer value T_IMU_1. Then, at operation 836, data fusion circuitry computes the total delay of the sensor data package. In the example of FIG. 2, this can be computed by data collection and counterstamp circuitry 336. In one embodiment this can be computed as:

t_IMU_1−t IMU_0.

At operation 838, data fusion circuitry (e.g. data collection and counterstamp circuitry 336) determines a counterstamp value corresponding to the measurement time. In one embodiment, this can be computed as:

C_imu−(t_IMU_1−t_IMU_0)*R_clock

Where, C_imu is the current counter value when the package is received, R_clock is the measured clock value (e.g. measured by counter system 332) and t_IMU_1−t_IMU_0 is a total delay of the sensor data package.

If IMU has a clock source other than from the data fusion circuitry, the delay time (t_IMU_1−t_IMU_0) measured by IMU clock may be converted into the time in data fusion circuitry clock units. Some methods can be used to calibrate or compensate the IMU clock for such a conversion. For example, the data fusion circuity may read the IMU timer twice at interval T. This T is the time measured by data fusion circuity clock. Then two timestamps stamped by the IMU are obtained in these two read operations. The difference of these two timestamps indicates the time lapse between these two read operations and it should be the same as T if the timer of IMU is the same as the timer in the data fusion circuity. If the difference is less then T, this means that the IMU timer is slower, while if the difference is greater than T, the IMU timer is faster. Considering various delays in read operations, the larger the interval T, the more accurate the measurement. After timer difference is measured, the time measured with the IMU timer or data fusion circuity clock can be converted to each other. In some scenarios, the delay is very small, or the frequency offset of clocks between the IMU and host are very small. The actual delay may depend on the requirement of the particular application. In these cases, the time conversion can be omitted. In other embodiments, the IMU clock may be derived from the host, in which case calibration or compensation may be avoided.

As seen in the example of FIG. 2, data fusion circuitry can compute an appropriate counterstamp value corresponding to the original measurement time when it receives data from a sensor unit. Examples of techniques that can be used to compute the counterstamp value are described above. As also noted above, the sensor data along with a computed counterstamp can be sent to the buffer (e.g. a FIFO buffer) for transmission to the data fusion core. In other embodiments, computation of the counterstamp can be done in the data fusion core itself, in which case data collection and counterstamp circuitry 336 would not need to compute this, but may still record appropriate values such as, for example, free running counter values, counter values at corresponding to the reference signal, counter values upon message arrival, timestamps of sensor devices (e.g., an IMU), the R_clock, and so on. This information could then be sent to data fusion core 338 for processing. Although the example of FIG. 2 illustrates multiple individual FIFOs 337, other embodiments can use other buffer configurations. For example, some embodiments can use single memory block with appropriate addressing and access signals, circular buffers, or other memory/buffer arrangements.

Data fusion core 338 performs a process of integrating or combining data from multiple sensors that may be used in computing a desired value (e.g., a position estimate, an alarm condition, a condition report, and so on). Generally speaking, a greater level of independence among the data sources for the sensors leads to a higher level of confidence in the output of the data fusion core. Some applications require that the output of the data fusion process be in a fixed interval or timing configuration that is independent of the arrival of the sensor data, while other Applications have no such requirement. This requirement can be achieved in some embodiments using interpolation or extrapolation, or a combination of the two. Some embodiments may use a Kalman filter to perform data fusion.

A data fusion system can be described with a state-space representation:

X_{K+1}=AX_{K}+BU_{K}+W,W˜N(0,Q)

where X_{K} is the system state vector (n×1) at timing t(k), A is matrix (n×n) relating transformation of X_{K} to X_{K+1}, U_{K} is the vector (n×1) containing any control inputs, B is the control input matrix (n×n) which applies the effect of control input, and W_{K} is a white noise sequence (n×1) representing process noise with a known covariance structure Q.

The observation/measurement of data fusion system can be described as:

Z_{K}=HX_{K}+V,V˜N(0,R)

where Z_{K} is the measurement/observation vector (m×1) at timing t(k), H is matrix (m×n) relating state vector X_{K} to observation at timing t(k) and V_{K} is measurement error/noise sequence (m×1) with known covariance structure R.

Based on the foregoing equations, a purpose of a Kalman filter is to compute an estimate value of state vector X_{K} and estimation error, which is P_{K}=cov(X_{K}−\hat{X}_{K}) (where \hat{X}_{K} is estimated state vector), at timing t(k) given an estimated state vector value \hat{X}_{K} and an estimation error P_{K-1}.

The estimation procedure with a Kalman filter is divided into 2 steps: a prediction step and an update step. The prediction step may be performed based on the dynamic equation:

\hat{X}_{K}⁻=A\hat{X}_{K-1}+BU_{K-1}P_{K}⁻=AP_{K-1}A^{T}+Q

Where the sign “−” on \hat{X}_{K}⁻ and P_{K}⁻ indicates that this is a predicted value (before update with measurement/observation results).

After the prediction state is done, the update step may be performed. The estimated value of \hat{X}_{K}⁻ and P_{K}⁻ may be updated with observation information as follows:

\hat{X}_{K}=\hat{X}_{K}⁻+K_{K}(Z_{K}−H\hat{X}_{K}⁻)P_{K}=P_{K}⁻−K_{K}HP_{K}⁻

where K_{K} is the Kalman filter gain, computed as:

K_{K}=P_{K}⁻H^{T}(HP_{K}⁻H^{T}+R)⁻¹

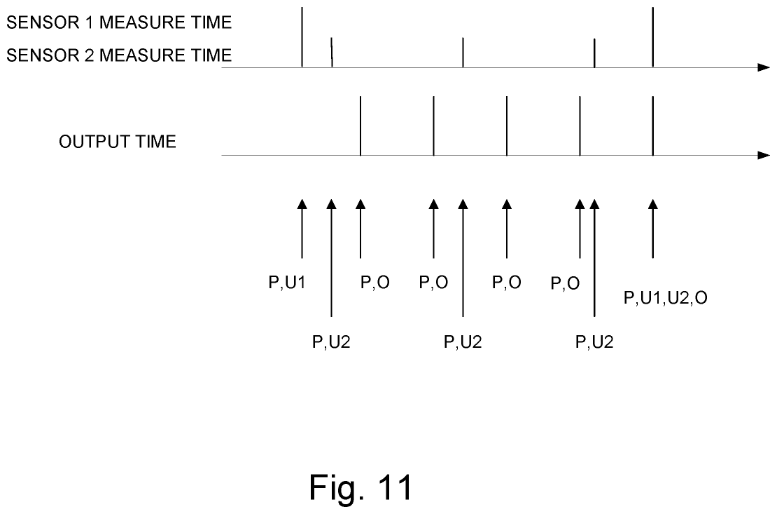

Embodiments may be implemented to avoid interpolation and extrapolation. In one example, the prediction equation may be performed upon the occurrence of the events: the measurement time of any sensor, and at the output time. Also, the update process may be performed for the measurement time of any sensor. FIG. 11 illustrates an example of different computations that can be performed at different times in the process in accordance with one embodiment of the systems and methods described herein.

Because the update step may be performed on an irregular timing basis, the process model in this example can be defined as:

Xₜ₍ₖ₊₁₎=A_{δt(k+1)}Xₜ₍ₖ₎+B_{δt(k+1)}Uₜ₍ₖ₎, W_{δt(k-1)}˜N(0,Q_{δt(k+1)})

Note that the matrix of A, B and Q would be the function of δt, and δt(k+1) and δt(k) could be different.

The observation model may be separated as:

Z_{1,t(k)}=H₁Xₜ₍ₖ₎+V₁,V₁˜N(0,R₁)Z_{2,t(k)}=H₂Xₜ₍ₖ₎+V₂,V₂˜N(0,R₂)

where Z_{i,t(k)} is the measurement/observation vector (m×1) from sensor i at timing t(k); Hi is the matrix (m×n) relating state vector Xₖ to observation from sensor i at timing t(k); Vᵢ is the measurement error/noise vector (m×1) with covariance structure Rᵢ; i is the sensor index, i=1, 2 in the example here. The invention works for a plurality of sensors.

Correspondingly, prediction equation (P) may be modified as (Algorithm P shown in FIG. 11):

\hat{X}ₜ₍ₖ₎=A_{δt(k)}\hat{X}ₜ₍ₖ₋₁₎+B_{δt(k)}Uₜ₍ₖ₋₁₎Pₜ₍ₖ₎=A_{δt(k)}Pₜ₍ₖ₋₁₎A_{δt(k)}^{T}+Q_{δt(k)}

Note that the “−” is removed from \hat{X}_{K}⁻ and P_{K}⁻. Accordingly, this process can be implemented to not differentiate the estimation error/value in prediction results or update results. If the prediction is followed by an update step, \hat{X}_{K} and P_{K} are the intermediate results at timing t(k) and the results may be used for the update. If the prediction is directly followed by an output, \hat{X}_{K} and P_{K} are the final results for timing t(k), and these may be used by processing of timing t(k+1).

The Kalman filter gain Kₘ(ₖ) in the update algorithm for sensor 1 data (Algorithm U1 in FIG. 11) can be written as:

K_{1,t(k)}=Pₜ₍ₖ₎H₁^{T}(H₁Pₜ₍ₖ₎H₁^{T}+R₁)⁻¹

Then the estimated value based on measurement from sensor 1 would be:

\hat{X}ₜ₍ₖ₎⇐\hat{X}ₜ₍ₖ₎+K_{1,t(k)}(Z_{1,t(k)}−H₁\hat{X}ₜ₍ₖ₎)Pₜ₍ₖ₎⇐Pₜ₍ₖ₎−K_{1,t(k)}H₁Pₜ₍ₖ₎

The Kalman filter gain K_{2,t(k)} in the update algorithm for sensor 2 data (Algorithm U2 in FIG. 11) can be written as:

K_{2,t(k)}=Pₜ₍ₖ₎H₂^{T}(H₂Pₜ₍ₖ₎H₁^{T}+R₂)⁻¹

Then the estimated value based on measurement from sensor 2 would be:

\hat{X}ₜ₍ₖ₎⇐\hat{X}ₜ₍ₖ₎+K_{2,t(k)}(Z_{2,t(k)}−H₂\hat{X}ₜ₍ₖ₎)Pₜ₍ₖ₎⇐Pₜ₍ₖ₎−K_{2,t(k)}H₂Pₜ₍ₖ₎

Note that the “−” is removed from \hat{X}_{K}⁻ and P_{K}⁻ for the update. \hat{X}_{K} and P_{K} can be results from algorithm P or algorithm U in FIG. 11.

At the output timing (e.g., Algorithm O), the output may be generated from state vector X. In some cases, the output can be directly taken from X, while in other cases, the output can be derived from state X.

As shown in the example illustrated in FIG. 11, at each timing event, the different combinations of algorithms can be as follows. As this illustrates, the prediction stage in these embodiments is used each time, but the order of the update is not important.

P+O (timing for output)

P+U1 (timing only for sensor 1 data arrival)

P+U2 (timing only for sensor 2 data arrival)

P+U1+U2 (timing for both sensor 1 data and sensor 2 data arrival)

P+U1+O (timing for sensor 1 data arrival and for output)

P+U2+O (timing for sensor 2 data arrival and for output)

P+U1+U2+O (timing for sensor 1 data and sensor 2 data arrival and for output)

In various embodiments, for scenarios where 2 observations of 2 sensors are independent, and a matrix for P can be written as a diagonal block matrix. Then the following 3 fusion methods:

### 1: P+U1+U2+O,

### 2: P+U2+U1+O, and

### 3: P+U (with combined data, large matrix)+O

Each provide the same results as a conventional Kalman filtering approach. In other scenarios, the results of these computational processes may vary, but they may still achieve comparable performance levels.

Although the foregoing method was described in the context of an example of Kalman filtering, this process works for other processing algorithms as well that utilize a prediction stage and an update stage. Examples of these may include variants of the Kalman filter such as, for example, an extended Kalman filter, unscented Kalman filter, and so on.

Depending on the application, embodiments can be implemented in which the data fusion circuitry is in a sleep mode and awakens at predetermined times or upon the occurrence of certain events. For example, embodiments may be implemented in which the data fusion circuitry awakens at a fixed timing interval such as, for example, multiple times within a given output interval. As another example, the data fusion circuitry can be configured to awaken upon the arrival of sensor data, upon an output event, or based on the fullness of its queue. In embodiments in which the data fusion circuitry awakens once upon an output event, all data fusion circuitry computations can be performed at that time. Data arriving after such an event may remain in a buffer until the next output timing event occurs. The output of the data fusion circuitry can include, for example, in addition to an estimate or other data output, information pertaining to timing of the output data, counterstamp information, timestamp information, and so on.

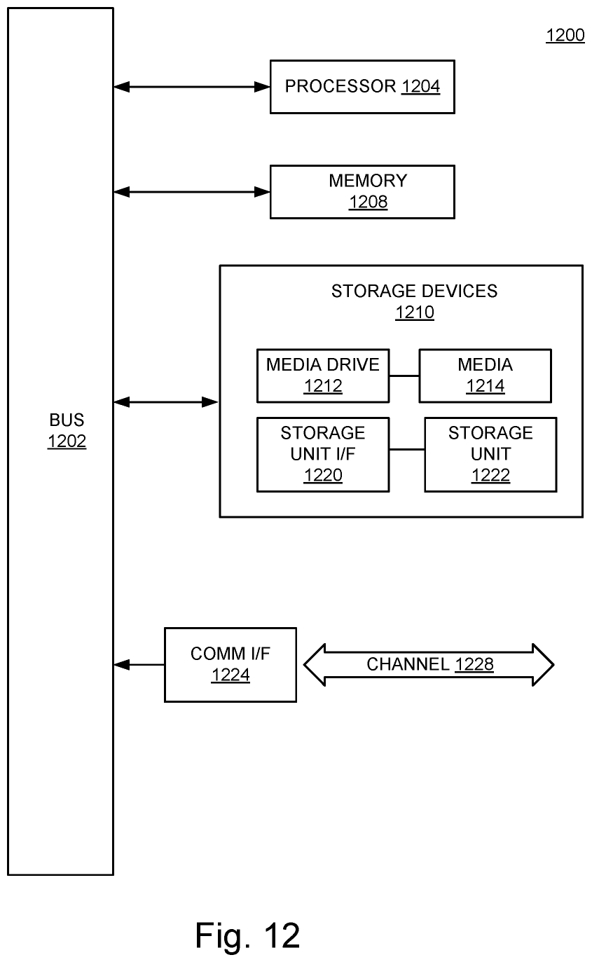

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. In other words, as would be apparent to one of ordinary skill in the art after reading this description, the various features and functionality described herein may be implemented in any given application and can be implemented in one or more separate or shared circuits in various combinations and permutations. Even though various features or elements of functionality may be individually described or claimed as separate circuits, one of ordinary skill in the art will understand that these features and functionality can be shared among one or more common circuits, and such description shall not require or imply that separate circuits are required to implement such features or functionality.

Where circuits are implemented in whole or in part using software, in one embodiment, these software elements can be implemented to operate with a computing or processing system capable of carrying out the functionality described with respect thereto. One such example computing system is shown in FIG. 12. Various embodiments are described in terms of this example-computing system 1200. After reading this description, it will become apparent to a person skilled in the relevant art how to implement the technology using other computing systems or architectures.

Referring now to FIG. 12, computing system 1200 may represent, for example, computing or processing capabilities found within desktop, laptop and notebook computers; hand-held computing devices (smart phones, cell phones, palmtops, tablets, etc.); mainframes, supercomputers, workstations or servers; or any other type of special-purpose or general-purpose computing devices as may be desirable or appropriate for a given application or environment. Computing system 1200 might also represent computing capabilities embedded within or otherwise available to a given device. For example, a computing system might be found in other electronic devices such as, for example, digital cameras, navigation systems, cellular telephones, portable computing devices, modems, routers, WAPs, terminals and other electronic devices that might include some form of processing capability.

Computing system 1200 might include, for example, one or more processors, controllers, control modules, or other processing devices, such as a processor 1204. Processor 1204 might be implemented using a general-purpose or special-purpose processing engine such as, for example, a microprocessor (whether single-, dual- or multi-core processor), signal processor, graphics processor (e.g., GPU) controller, or other control logic. In the illustrated example, processor 1204 is connected to a bus 1202, although any communication medium can be used to facilitate interaction with other components of computing system 1200 or to communicate externally.

Computing system 1200 might also include one or more memory modules, simply referred to herein as main memory 1208. For example, in some embodiments random access memory (RAM) or other dynamic memory, might be used for storing information and instructions to be executed by processor 1204. Main memory 1208 might also be used for storing temporary variables or other intermediate information during execution of instructions to be executed by processor 1204. Computing system 1200 might likewise include a read only memory (“ROM”) or other static storage device coupled to bus 1202 for storing static information and instructions for processor 1204.

The computing system 1200 might also include one or more various forms of information storage mechanism 1210, which might include, for example, a media drive 1212 and a storage unit interface 1220. The media drive 1212 might include a drive or other mechanism to support fixed or removable storage media 1214. For example, a hard disk drive, a floppy disk drive, a magnetic tape drive, an optical disk drive, a CD or DVD drive (R or RW), a flash drive, or other removable or fixed media drive might be provided. Accordingly, storage media 1214 might include, for example, a hard disk, a floppy disk, magnetic tape, cartridge, optical disk, a CD or DVD, or other fixed or removable medium that is read by, written to or accessed by media drive 1212. As these examples illustrate, the storage media 1214 can include a computer usable storage medium having stored therein computer software or data.

In alternative embodiments, information storage mechanism 1210 might include other similar instrumentalities for allowing computer programs or other instructions or data to be loaded into computing system 1200. Such instrumentalities might include, for example, a fixed or removable storage unit 1222 and an interface 1220. Examples of such storage units 1222 and interfaces 1220 can include a program cartridge and cartridge interface, a removable memory (for example, a flash memory or other removable memory module) and memory slot, a flash drive and associated slot (for example, a USB drive), a PCMCIA slot and card, and other fixed or removable storage units 1222 and interfaces 1220 that allow software and data to be transferred from the storage unit 1222 to computing system 1200.

Computing system 1200 might also include a communications interface 1224. Communications interface 1224 might be used to allow software and data to be transferred between computing system 1200 and external devices. Examples of communications interface 1224 might include a modem or softmodem, a network interface (such as an Ethernet, network interface card, WiMedia, IEEE 802.XX, Bluetooth® or other interface), a communications port (such as for example, a USB port, IR port, RS232 port, or other port), or other communications interface. Software and data transferred via communications interface 1224 might typically be carried on signals, which can be electronic, electromagnetic (which includes optical) or other signals capable of being exchanged by a given communications interface 1224. These signals might be provided to communications interface 1224 via a channel 1228. This channel 1228 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1208, storage unit 1220, media 1214, and channel 1228. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing system 1200 to perform features or functions of the disclosed technology as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A multi-sensor data fusion system, comprising:
a counter circuit, comprising a counter and a plurality of registers, the counter circuit measuring a clock rate of a local clock and outputting a difference value associated with the local clock and a counter value;
a data collection and counterstamp circuit comprising a plurality of inputs to receive data from a plurality of sensors and a plurality of outputs, wherein the sensors are not synchronized with the multi-sensor data fusion system, and wherein the data collection and counterstamp circuit determines a sample delay for received sensor data and determines a timestamp corresponding to the measurement time for received sensor data using the determined sample delay; and
a data fusion circuit comprising a plurality of inputs to receive sensor data from the data collection and counter stamp circuit, the data fusion circuit outputting information with even output timing, synchronized with an application processor.

2. The multi-sensor data fusion system of claim 1, wherein the data collection and counterstamp circuit time stamps received sensor data with the determined timestamp, and sends sensor data with its associated timestamp reflecting its sensing time to the data fusion circuit.

3. The multi-sensor data fusion system of claim 2, wherein the data collection and counterstamp circuit determines the timestamp using the counter value from the local clock, the measured clock rate of the local clock and the determined sample delay.

4. The multi-sensor data fusion system of claim 2, wherein sensor data received from sensors in a sensor system includes a sensor time stamp and the sensor system provides the reference timing signal, further wherein data collection and counter stamp circuit generates the timestamp using the counter value when a reference point from the reference timing signal is received.

5. The multi-sensor data fusion system of claim 1, further comprising a plurality of buffers coupled between outputs of the data collection and counter stamp circuit and inputs of the data fusion circuit.

6. The multi-sensor data fusion system of claim 1, wherein the counter circuit comprises an input to receive a local clock signal and an input to receive a reference timing signal, further wherein the counter circuit uses the reference timing signal to calibrate the local clock signal.

7. The multi-sensor data fusion system of claim 6, wherein calibrating the local clock signal comprises determining a difference between a value of the counter at a first reference time of the reference timing signal and a second reference time of the reference timing signal.

8. The multi-sensor data fusion system of claim 1, wherein the data fusion circuit comprises a Kalman filter to process sensor data received from the data collection and counter stamp circuit.

9. The multi-sensor data fusion system of claim 8, wherein the data fusion circuit comprises a prediction matrix and an update matrix, wherein a prediction is performed using the prediction matrix at the measurement time of any sensor, and the output time, and an update is performed at the measurement time of a sensor using the update matrix associated with the sensor. The measurement times of sensors and the time of fusion output are on an irregular timing basis.

10. (canceled)

11. (canceled)

12. (canceled)

13. The multi-sensor data fusion system of claim 9, wherein the data fusion circuit comprises state-space equations having a variable updating interval, and de-coupled updating and prediction times.

14. The multi-sensor data fusion system of claim 9, wherein the data fusion circuit performs prediction and updating in the order of sensing time of each sensor data sample.

15. (canceled)

16. The multi-sensor data fusion system of claim 9, wherein the data fusion circuit performs prediction corresponding to the requested output time.

17. A method for performing multi-sensor data fusion system, comprising:
a counter circuit measuring a clock rate of a local clock and outputting a difference value associated with the local clock and a counter value;
a data collection and counterstamp circuit determining a sample delay for received sensor data and determines a timestamp corresponding to the measurement time for received sensor data using the determined sample delay; and
a data fusion circuit outputting information with even output timing, synchronized with an application processor.

18. The method of claim 17, further comprising the data collection and counterstamp circuit time stamping received sensor data with the determined timestamp, and sending sensor data with its associated timestamp reflecting its sensing time to the data fusion circuit.

19. The method of claim 18, wherein the data collection and counterstamp circuit determines the timestamp using the counter value from the local clock, the measured clock rate of the local clock and the determined sample delay.

20. The method of claim 18, wherein sensor data received from sensors in a sensor system includes a sensor time stamp and the sensor system provides the reference timing signal, further wherein data collection and counter stamp circuit generates the timestamp using the counter value when a reference point from the reference timing signal is received.

21. The method of claim 17, wherein the counter circuit comprises an input to receive a local clock signal and an input to receive a reference timing signal, further wherein the counter circuit uses the reference timing signal to calibrate the local clock signal.

22. The method of claim 21, wherein calibrating the local clock signal comprises determining a difference between a value of the counter at a first reference time of the reference timing signal and a second reference time of the reference timing signal.

23. The method of claim 17, wherein the data fusion circuit comprises a Kalman filter to process sensor data received from the data collection and counter stamp circuit.

24. The method of claim 23, wherein the data fusion circuit comprises a prediction matrix and an update matrix, wherein a prediction is performed using the prediction matrix at the measurement time of any sensor, and the output time, and an update is performed at the measurement time of a sensor using the update matrix associated with the sensor. The measurement times of sensors and the time of fusion output are on an irregular timing basis.

25. (canceled)

26. (canceled)

27. (canceled)
